(19) United States
(12) Patent Application Publication
(10) Pub. No.: US 2015/0264776 A1
(43) Pub. Date: Sep. 17, 2015

(54) DISTRIBUTED STREET LIGHTS ENERGY REMOTE MONITORING, COMMAND AND CONTROL

(71) Applicants: Alice GONZALEZ, Emerson, NJ (US); PETRA SOLAR, INC., South Plainfield, NJ (US)

(72) Inventors: Ruba Akram Amarin, Piscataway, NJ (US); Alice Gonzalez, Emerson, NJ (US); Nasser Kutkut, Orlando, FL (US)

(73) Assignee: PETRA SOLAR, INC., South Plainfield, NJ (US)

(21) Appl. No.: 14/430,603

(22) PCT Filed: Sep. 24, 2013
(86) PCT No.: PCT/US13/61410

§ 371 Date: Mar. 24, 2015

Related U.S. Application Data
(60) Provisional application No. 61/704,631, filed on Sep. 24, 2012.

(51) Int. Cl. H05B 37/02; H05B 37/03; H05B 33/08

(52) U.S. Cl. CPC H05B 37/0218; H05B 33/0854; H05B 33/0893; H05B 37/0272; H05B 37/0254; H05B 37/03

(57) ABSTRACT

Monitoring, control, and management of a plurality of street lights may be provided. First, a lighting policy comprising a list of local variables and a status of a street light corresponding to each of the plurality of local variables may be received. Next, a sensed local variable may be received. A status of the street light for the sensed local variable may be determined based on the lighting policy. A command may be generated, based in the determined status, for a controller associated with the street light.

### CROSS REFERENCE TO RELATED APPLICATION

This application is being filed on 24 Sep. 2013, as a PCT International Patent application and claims priority to U.S. Patent Application Ser. No. 61/704,631 filed on 24 Sep. 2012, the disclosure of which is incorporated herein by reference in its entirety.

### BACKGROUND

Street lights, also referred to as lampposts, street lamps, light standards, or lamp standards, may be raised source of light on an edge of a road or a walkway. The street lights are switched on/off or lit at a certain time of the day. The street lights are switched on/off either using a switch or automatically using a photocell. The photocells are mounted usually on top of the street lights fixture. Monitoring and managing these street lights poses a challenge because of their sheer number and location.

### BRIEF DESCRIPTION OF THE DRAWINGS

The accompanying drawings, which are incorporated in and constitute a part of this disclosure, illustrate various embodiments of the present disclosure. In the drawings:

FIG. 1 is an operating environment;

FIG. 2 is a block diagram of a street light controller;

FIG. 3 is a block diagram of an access point;

FIG. 4 is a block diagram of a network operation center; and

FIG. 5 is a flow diagram of a method for managing street lights.

### DETAILED DESCRIPTION

### Overview

Monitoring, command, control, and management of a plurality of street lights may be provided. First, a lighting policy comprising a plurality of local variables and a status of a street light corresponding to each of the plurality of local variables may be received. Next, a sensed local variable may be received. The status of the street light may be determined based on the sensed local variable and the lighting policy. A command may be generated based on the determined status for a controller associated with the street light.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Street lights may be raised source of light on an edge of a road or a walkway. The street lights may require constant monitoring and maintenance. For example, there may be numerous street lights installed in a region. Each of these numerous street lights may consume certain amount of energy when switched on. Hence the street lights may be required to be switched on judiciously to minimize energy consumption. Moreover, each of these street lights may have multiple components, such as a light emitting member, a cover for the light emitting member, a support for the light emitting member, and wires connecting the street lights to the electricity supply. Each of these multiple components may require constant monitoring and maintenance support for proper functioning of the street lights. Monitoring the street lights and components of the street light, may require a visit to the location of the street lights, and perform a manual inspection. Such exercise may require a large amount of human capital. For example, an agency responsible for installation and maintenance of these street lights may have to employ a large number of people to constantly monitor and maintain the street lights, apart from paying energy bills.

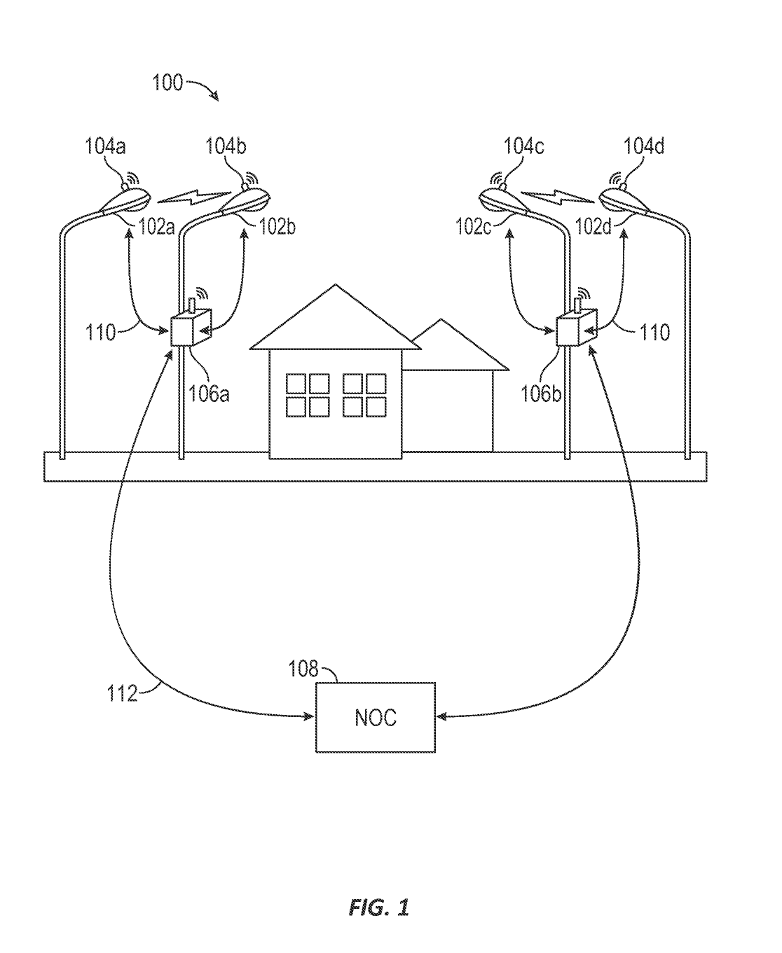

Consistent with embodiments of the disclosure, methods and systems for monitoring, command, and control of street lights may be provided. The embodiments of the disclosure will be described in more detail in following sections with reference to attached drawings. FIG. 1 illustrates a block diagram of a system 100 in which embodiments of the disclosure may be practiced. As shown in FIG. 1, system 100 may include a plurality of street lights 102a, 102b, 102c, and 102d (collectively referred to as street lights 102), a plurality of controllers 104a, 104b, 104c, and 104d (collectively referred to as at controllers 104), a plurality of access points 106a, 106b (collectively referred to as access points 106), and a network operation center (NOC) 108.

Each of street lights 102 may comprise a light emitting member mounted on a pole fixture. The light emitting member may comprise, but not limited to, a light emitting diode (LED) lamp, a high pressure sodium (HPS) lamp, a high intensity discharge (HID) lamp, and an induction lamp. The light emitting member of street lights 102 may be controlled by at least one of controllers 104. For example, the light emitting member of street light 102a may be controlled by controller 104a. Controllers 104 may be an intelligent controller, and may be installed on top or bottom of street lights 102 pole fixtures. Controllers 104 may be mounted in different ways including, for example twist lock install, threaded nipple bolt-in or via providing 3-5-prong retrofit install.

Each of controllers 104 may be configured to communicate with at least one of access points 106. For example, each of controllers 104 may be configured to be connected to the nearest access point. Controllers 104a and 104b may be connected to access point 106a while controllers 104c and 104d may be connected to access point 106b. Controllers 104 may be configured to communicate with access points 106 through a network 110. Network 110 may be a Zigbee, a WIFI, power-line communications, an EDGE network, a third generation (3G) network, a fourth generation (4G) network, a fiber network or any other reliable communication standard or protocol.

Each of access points 106 may be configured to communicate with NOC 108. For example, access point 106a and access point 106b may be configured to communicate with NOC 108 through network 112. Network 112 may be a Zigbee, a WIFI, power-line communications, an EDGE network, a third generation (3G) network, a fourth generation (4G) network, a fiber network or any other reliable communication standard or protocol.

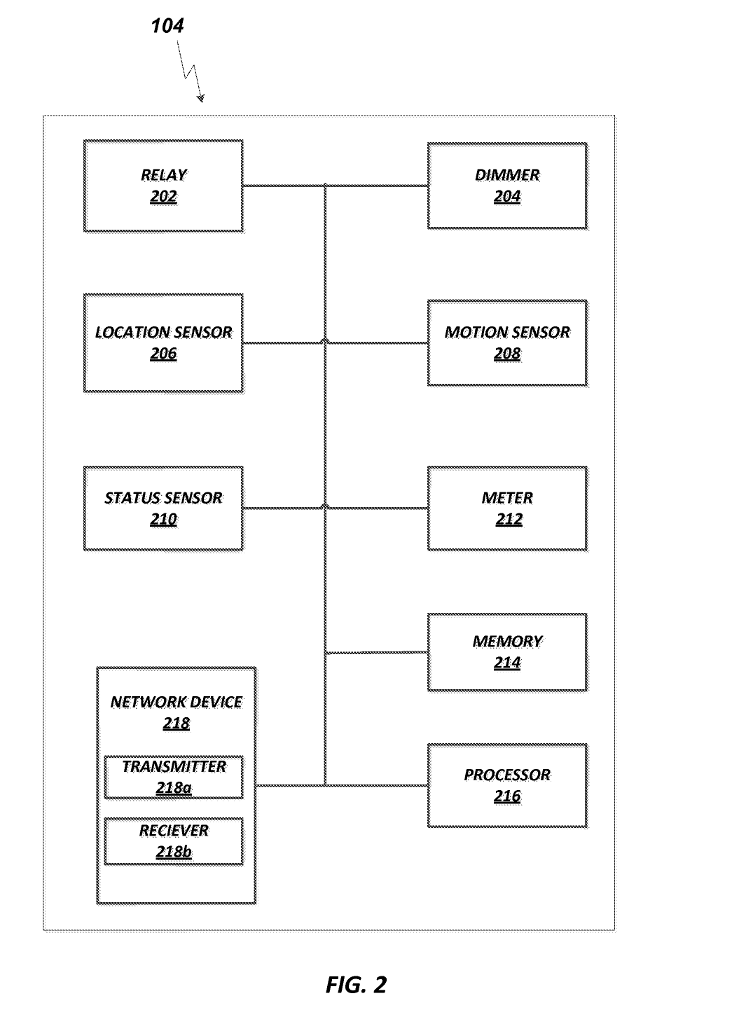

FIG. 2 is a block diagram of controller 104a. Controller 104a may include a relay 202, a dimmer 204, a location sensor 206, a motion sensor 208, a status sensor 210, a metering device 212, a memory 214, a processor 216, and a network device 218. Relay 202 may be a device configured to switch on or switch off street light 102a. Dimmer 204 may be a device configured to adjust an amount of light being emitted by the light emitting member of street light 102a. Relay 202 and dimmer 204 may be compatible with different types of light emitting members, including: a light emitting diode (LED) lamp, a high pressure sodium (HPS) lamp, a high intensity discharge (HID) lamp, and an induction lamp for example.

Location sensor 206 may be configured to sense or store information regarding a physical location of street light 102a. For example, location sensor 206 may provide information regarding physical coordinates or a street address of the location of street light 102a. The location information may be used to identify the nearest access point (e.g. access point 106a) for street light 102a. In addition, the location information may further be used by access point 106a when sending commands or scheduling any maintenance at street light 102a. The location information may be stored in memory 214 or a memory associated with location sensor 206 at a time of installation of street light 102a.

Motion sensor 208 may sense movement around street light 102a. For example, motion sensor 208 may be configured to sense movement of a pedestrian or a vehicle near street light 102a. Based on output from motion sensor 208, commands may be generated for relay 202 or dimmer 204. For example, if motion sensor 208 detects movement of a pedestrian around street light 102a, a command may be generated for relay 202 to switch on street light 102a. In another example, if motion sensor 208 does not detect any movement for a predetermined amount of time, a command may be generated for relay 202 to switch off street light 102a, or for dimmer 204 to decrease intensity of street light 102a.

Status sensor 210 may be configured to monitor a status of street light 102a. For example, status sensor 210 may be configured to monitor if the light emitting member of street light 102a is working properly. As another example, status sensor 210 may monitor if motion sensor 208 is working properly. Status sensor 210 may further be configured to generate a message or an alarm based on a detection of any abnormality in working of street light 102a or any part of controller 104a. The message/alarm generated by status sensor 210 may be sent to access point 106a and subsequently relayed to NOC 108. The message/alarm may be monitored by access point 106a or NOC 108, and subsequently may be reported for scheduling maintenance.

Metering device 212 may be configured to measure an amount of energy consumed by street light 102a. For example, metering device 212 may be configured to measure the amount of energy consumed by street light 102a. Metering device 212 may further be configured to store the measured amount of energy consumed by street light 102a in memory 214. The energy consumption data for street light 102a may be stored in memory 214 with a timestamp and a unique identifier identifying street light 102a. The energy consumption data stored in memory 214 may be transmitted to access point 106a and subsequently to NOC 108 on a periodic basis.

Memory 214 may be used by various sensors described above to store the sensed local variable. For example, the sensed local variable from location sensor 206, motion sensor 208, status sensor 210, and metering device 212 may be stored in memory 214. The sensed local variable from each sensors of controller 104a may be stored along with an identifier identifying the sensor, identifying street light 102a, and a timestamp. The sensed local variables stored in memory 214 may be relayed to NOC 108 via access point 106a. The sensed local variables stored in memory 214 may further be used by processor 216 to generate commands locally for street light 102a. For example, processor 216 may generate command for relay 202 to switch on street light 102a when motion sensor 208 detects movement of a pedestrian. These local commands may be generated based on a lighting policy stored in memory 214. The lighting policy may include a plurality of local variables and a status of street light 102a corresponding to each of the plurality of local variables.

Controller 104a may further include a photo sensor and a time sensor (not shown). The photo sensor may sense amount of light in vicinity of street light 102a. Processor 216 may use the amount of light sensed by the photo sensor and generate a local command to adjust output of the light emitting member of street light 102a. For example, processor 216 may generate a local command for relay 202 to switch off street light 102a when the sensed amount of light is above a predetermined threshold. Time sensor may sense a current time at the location of street lights 102. The current time information provided by the time sensor may be used by processor 216 to perform scheduled switching on and switching off of street light 102a.

Network device 218 may receive commands from and send data to access points 106a. Network device 218 may include a transmitter 218a and a receiver 218b. Transmitter 218a may send data, such as energy consumption data and status data, over communication network 110 to access point 106a. Transmitter 218a may further send energy consumption data and status information, corresponding to street light 102a, to access point 106a either directly or hoping through another street light (e.g. street light 102b). Receiver 218b may receive commands and the lighting policy from access point 106a via communication network 110. Receiver 218b may further receive data sent by another street light 102b via communication network 110.

In one embodiment, processor 216 may be configured to generate commands to relay 202 or dimmer 204 based on the lighting policy received from access point 106a or NOC 108. For example, processor 216 may be configured to generate commands to switch on street light 102a at a predetermined time every day. Similarly processor 216 may be configured to switch off street light at a predetermined time every day. Processor 216 may be further configured to override commands received from access point 106a based on change of local variables. For example, processor 216 may be configured to switch on/off street light 102a when there is change in natural light at street light 102a.

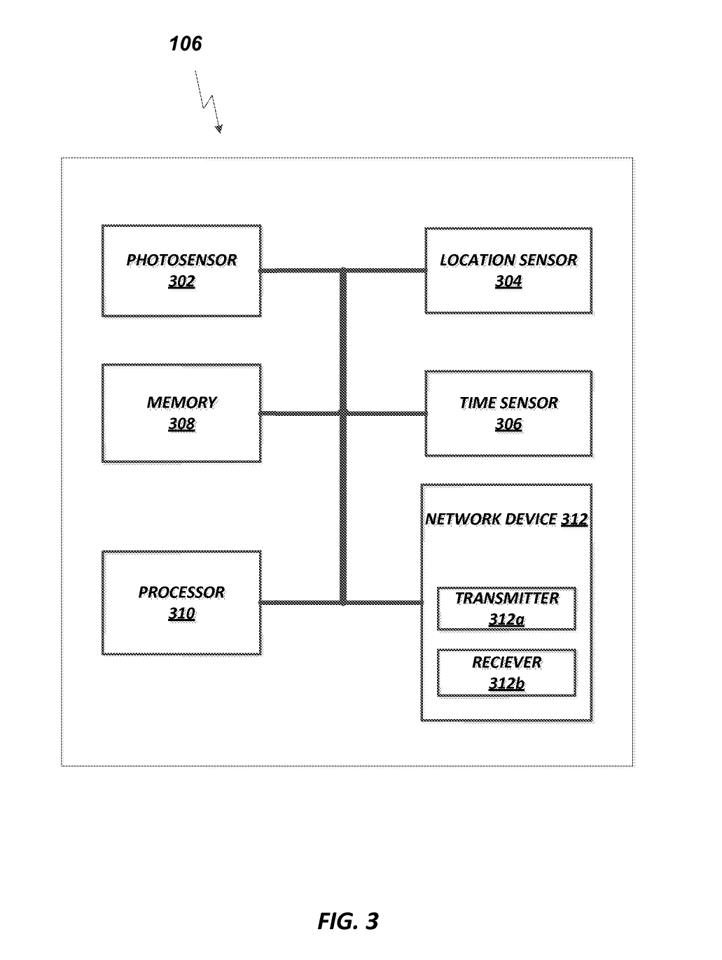

FIG. 3 is a block diagram of access point 106a. Access point 106a may be configured to monitor and report on operation and health of street lights 102a and 102b. For example, access point 106a may be configured to accumulate amount of energy consumed by street lights 102a and 102b, as well as status report from status sensor 210 of street lights 102a, and 102b. Access point 106a may relay the accumulated amount of energy consumed and repair alerts based on report from status sensor 210 to NOC 108. Thus, access point 106a may be configured to constantly monitor and provide real time status updates on critical operating parameters thereby supporting automatic outage detection and faster repair response time.

As shown in FIG. 3, access point 106a may include a photo sensor 302, a location sensor 304, a time sensor 306, a memory 308, a processor 310, and a network device 312. Photo sensor 302 may be configured to act as a light sensor by sensing amount of light. The sensed amount of light may be provided to processor 310 via memory 308. Although only one photo sensor is shown in FIG. 3, access point 106a may include more than one photo sensor for redundancy and failover feature.

Location sensor 304 may be configured to sense and store data regarding physical location of access point 106a. For example, location sensor 304 may provide data regarding physical coordinates or street address of the location of access point 106a. The location data may be used by NOC 108 to identify the nearest access point 106a for street light 102a. For example, the location data may be used by NOC 108 for sending commands or lighting policy, and by street light 102a for sending the energy consumption data and the status data.

Time sensor 306 may be configured to provide timing information at the location of access point 106a. For example, time sensor 306 may be configured to track a current time at the location of access point 106a. The timing information provided by time sensor 306 may be used by processor 310 in performing scheduled switching on and switching off of street light 102a.

Memory 308 may be configured to store various data received at access point 106a. For example, memory 308 may be configured to store energy consumption data received from controller 104a. As another example, memory 308 may be configured to store lighting schedule received from NOC 108.

Processor 310 may be configured to generate commands for street lights 102a and 102b. For example, processor 310 may be configured to generate command for street lights 102a and 102b based on the amount of light sensed by photo sensor 302 and a lighting policy stored in memory 308. Based on the amount of light, processor 310 may generate command to switch on street lights 102a and 102b. In addition, processor 310 may be configured to generate command based on a current time and the lighting policy. For example, processor 310 may be configured to, based on current time and the lighting policy, generate commands to switch on street lights 102a and 102b.

Commands generated by processor 310 may be communicated to controllers 104a and 104b via network device 312. Network device 312 may include a transmitter 312a and a receiver 312b. Transmitter 312a may be configured to send the commands generated by processor 310 over communication network 110. In addition, transmitter 312a may be configured to forward various data, such as data received from controllers 104a and 104b, alerts received from controllers 104a and 104b, and data stored in memory 308, to NOC 108 via communication network 112. Receiver 312b may be configured to receive data from NOC 108 over communication network 112. In addition, receiver 312b may be configured to receive data sent by controllers 104a and 104b over communication network 110.

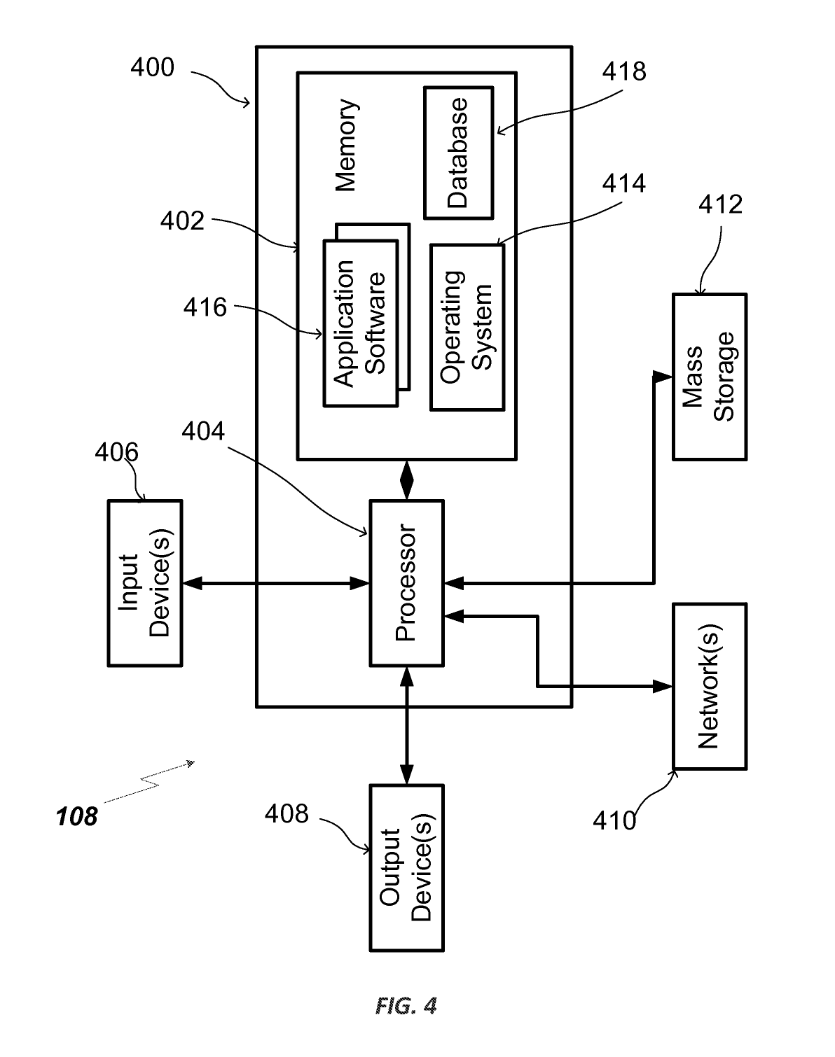

FIG. 4 is a block diagram of NOC 108. NOC 108 may be a computer system configured to monitor, control, and manage street lights 102. As shown in FIG. 4, NOC 108 may include at least one processor 404 coupled to a memory 402. Processor 404 may represent one or more processors (e.g., microprocessors), and memory 402 may represent random access memory (RAM) devices comprising a main storage of NOC 108, as well as any supplemental levels of memory e.g., cache memories, non-volatile or back-up memories (e.g. Programmable or flash memories), read-only memories, etc. In addition, memory 402 may be considered to include memory storage physically located elsewhere in NOC 108, e.g. any cache memory in processor 404 as well as any storage capacity used as a virtual memory, e.g., as stored on a mass storage device 412.

NOC 108 may be configured to receive a number of inputs and outputs for communicating information externally. For example, NOC 108 may be configured to receive inputs from access point 106, and a user, or an operator. For interface with the user or the operator, NOC 108 may include one or more user input devices 406 (e.g., a keyboard, a mouse, imaging device, etc.), and one or more output devices 408 (e.g., a liquid crystal display (LCD) panel, a sound playback device (speaker, etc.))

For additional storage, NOC 108 may also include one or more mass storage devices 412, e.g., a floppy or other removable disk drive, a hard disk drive, a direct access storage device (DASD), an optical drive (e.g. a compact disk (CD) drive, a digital versatile disk (DVD) drive, etc.), and a tape drive, among others. Furthermore, NOC 108 may include an interface with one or more networks 410 (e.g., a local area network (LAN), a wide area network (WAN), a wireless network, and/or the internet among others) to permit the communication of information with other computers coupled to the networks. NOC 108 may include suitable analog and/or digital interfaces between processor 404 and each of the components 402, 406, 408, and 410.

NOC 108 may operate under the control of an operating system 414, and execute various computer software applications, components, programs, objects, modules, etc. to implement the techniques described in this description. Moreover, various applications, components, programs, objects, etc., collectively indicated by reference 416, may also execute on one or more processors in another computer coupled to NOC 108 via a network 410, e.g. in a distributed computing environment, whereby the processing required to implement the functions of a computer program may be allocated to multiple computers over a network. Application software 416 may include a set of instructions which, when executed by processor 404, may cause NOC 108 to manage street lights 102 as described. NOC 108 may also include a database 418. Database 418 may be used to store the energy consumption data received for street lights 102. Database 418 may further include various commands and controls for street lights 102.

In one embodiment, NOC 108 may provide a web based interface, or an energy management platform, for managing street light 102. For example, the web based interface may provide an interface for a user to determine and create the lighting policy for street lights 102. The lighting policy may determine different devices' functionalities, i.e. ON/OFF or dimming features. For example, the lighting policy may include a dusk to down lighting schedule. The lighting schedules may be defined for various periodicities i.e. daily, monthly, seasonal and a onetime event. The web base interface may further provide an adaptive control via the amount of light, motion, traffic patterns to dim, switch on or switch off street lights 102 based on specified conditions.

In another embodiment, NOC 108 may be configured to monitor and manage street lights 102. For example, based on the status data received from status sensor 210 may schedule a maintenance of street lights 102. The maintenance schedule may include the location of street light 102a, name and details of an affected element of street lights 102, and type of maintenance needed for the affected element. In addition, the maintenance schedule may include additional information such as whether the affected element needs to be replaced. Furthermore, NOC 108 may be configured to provide an audit on the amount of energy consumed by street lights 102. For example, NOC 108 may be configured to provide statistical analysis of the amount of energy consumed by street lights 102.

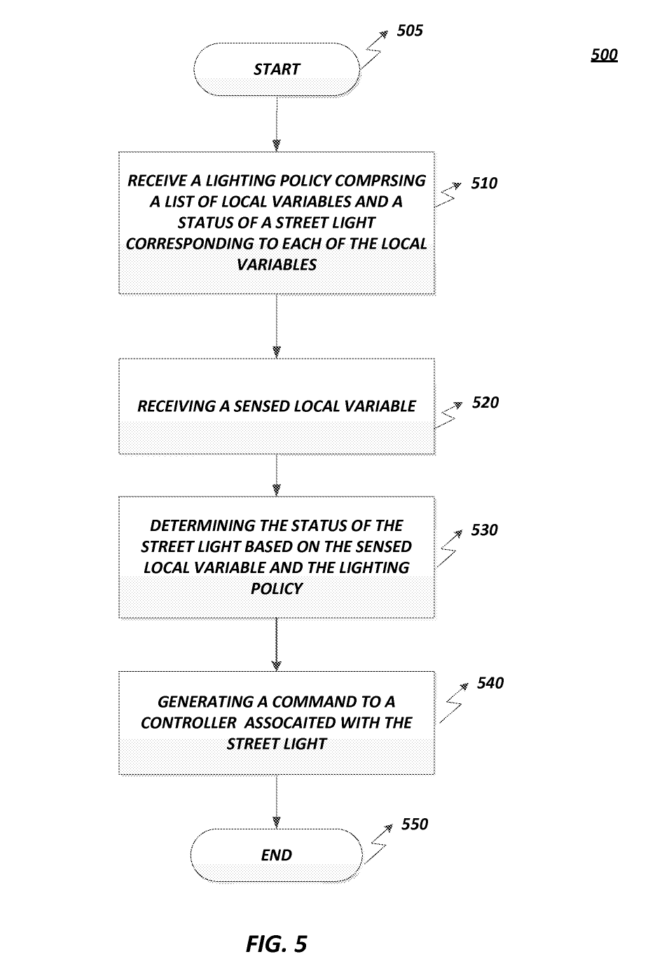

Although the NOC 108 is shown to include a single computer system, it may be apparent to those skilled in the art that NOC 108 may be a distributed computing system with multiple processors and memory devices or a cloud computing system. Processor 404 of NOC 108 may be configured to execute a method for managing distributed energy resources. An example flow diagram of a method of managing distributed energy resources is illustrated in FIG. 5.

FIG. 5 is a flow chart setting forth the general stages involved in a method 500 consistent with embodiments of the disclosure for control, management, and monitoring for distributed street lights 102. Method 500 may be implemented using any one of controllers 104, access points 106, or NOC 108. Ways to implement method 500 will be described in greater detail below.

As shown in FIG. 5, method 500 may begin at starting block 505 and proceed to stage 510 where a lightening policy may be received. The lighting policy may include a plurality of local variables and a status of a street light corresponding to each of the plurality of local variables. For example, lighting policy may include a dusk to down lighting schedule. The lighting policy may be received at access points 106, or controllers 104 from NOC 108. The local variables may include an amount of natural light, a local time, detection of motion around the street light, etc. The status may include an on status, an off status, and a dim status.

From stage 510, where access point 106 receives the lighting policy from NOC 108, method 500 may advance to stage 520 where local variable sensed by a sensor may be received. For example, access point 106 may receive a detection of motion by a motion sensor 208 at street light 102. As another example, an amount of light sensed by photo sensor 302 may be received at access point 106. As yet another example, access point 106 may receive a current local time sensed by time sensor 306.

After access point 106 receives the local variable at stage 520, method 500 may advance to stage 530 where the status of street light 102 may be determined. For example, the status of street light 102 may be determined by access point 106 based on the sensed local variable and the lighting policy. Access point 106 may determine the status of street light 102 by performing in a lookup operation in the lighting policy for the sensed local variable. For example, lighting policy may include a dusk to down schedule, and access point 106 based on the current local time sensed by time sensor 306, may determine whether street light 102 should be switched on, switched off or dimmed.

Once, access point 106 has determined the status of street light 102 at stage 530, method 500 may advance to stage 540 where a command may be generated for a controller 104 associated with street light 102. For example, access point 106 may generate a command to switch on street light 102 based on the determined status. The command generated by access point 106 may be sent to controller 104 using communication network 110. After access point 106 has generated command for controller 104 at stage 540, method 500 may end at stage 550.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a lighting policy comprising a plurality of local variables and a status of a street light corresponding to each of the plurality of local variables;
receiving a sensed local variable;
determining the status of the street light for the sensed local variable based on the lighting policy; and
generating a command, based on the determined status, to a controller associated with the street light.

2. The method of claim 1, wherein receiving the lighting policy comprising the plurality of local variables comprises receiving the lighting policy comprising the plurality of local variables, wherein the plurality of local variables are at least one of: an amount of natural light, a current time, and a change in motion.

3. The method of claim 1, wherein generating the command comprises generating the command wherein the command comprises at least one of switch on the street light, switch off the street light, and dim the street light.

4. The method of claim 1, further comprising receiving a status data for the street light.

5. The method of claim 4, wherein receiving the status data comprises receiving the status data wherein the status data is at least one of: an amount of energy consumed by the street light, physical location of the street light, and outage notification of the street light.

6. The method of claim 5, further comprising:
scheduling a maintenance of the street light based on the received the outage notification.

7. The method of claim 6, wherein scheduling the maintenance further comprising:
providing the physical location of the street light.

8. The method of claim 4, further comprising:
performing an energy audit of the street light, wherein performing the audit comprises generating an audit report on the amount of energy consumed by the street light.

9. The method of claim 1, wherein receiving the sensed local variable comprises receiving an amount of natural light sensed by a photo sensor, and wherein generating the command comprises generating the command to switch on the street light when the amount of natural light is below a predetermined threshold.

10. A system comprising:
an access point configured to communicate with a plurality of street lights, wherein the access point comprises a sensor, a memory, and a processor, and wherein:
the sensor is configured to sense a local variable,
the processor is configured to:
receive the sensed local variable from the sensor,
generate a command for at least one of the plurality of street lights based on the sensed local variable and a lighting policy; and
the access point is configured to send the generated command to the at least one of the plurality of street lights.

11. The system of claim 10, wherein the generated command comprises at least one of: switch on the at least one of the plurality of street lights, switch off the at least one of the plurality of street lights, and dim the at least one of the plurality of street lights.

12. The system of claim 11, wherein the access point is further configured to receive status data from each of the plurality of street lights, wherein the status data is at least one of an amount of energy consumed, location information, and outage indication of a light emitting member.

13. The system of claim 12, wherein the access point is further configured to forward the status data to a network operation center.

14. The system of claim 13, wherein the network operation center is configured to generate a maintenance schedule for the plurality of street lights based on the outage indication and the location information.

15. The system of claim 13, wherein the network operation center is further configured to perform energy audit of the plurality of street based on the amount of energy consumed.

16. The system of claim 10, wherein the generated command is sent to the at least one of the plurality of street lights via smart grid system.

17. The system of claim 10, wherein the lighting policy comprises a dusk to down lighting schedule, wherein the sensor is a time sensor, wherein the sensed local variable is a current time, and wherein the processor is further configured to generate the command to switch off the at least one of the plurality of street lights based on the current time and the dusk to down lighting schedule.

18. The system of claim 10, wherein the sensor is a motion sensor, wherein the sensed local variable is a movement of a pedestrian, and wherein the processor is further configured to generate the command to switch on the at least one of the plurality of street lights based on the sensed movement of the pedestrian.

19. The system of claim 10, wherein the sensor is a motion sensor, wherein the sensed local variable is a movement of a pedestrian, and wherein the processor is further configured to generate the command to switch off the at least one of the plurality of street lights when the motion sensor does not sense the movement of the pedestrian for a predetermined period of time.

20. A computer readable medium that stores a set of instructions which when executed perform a method comprising:
receiving a sensed local variable from a sensor;
determine a status for a plurality of street lights based on the sensed local variable and a lighting policy, wherein the lighting policy comprises a plurality of local variables and the status corresponding to each of the plurality of the local variables;
determine a current status of the plurality of street lights;
comparing the current status with the determined status;
generating, based on the comparison, a command for at least one of the plurality of street lights; and
sending the generated command to the at least one of the plurality of street lights.
